(19) United States
(12) Patent Application Publication
(10) Pub. No.: US 2005/0289235 A1
(43) Pub. Date: Dec. 29, 2005

(54) Information display apparatus, information display method, and computer program

(75) Inventors: Toshinari Suematsu, Saitama (JP); Satoshi Nagata, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 11/149,357

(22) Filed: Jun. 10, 2005

(30) Foreign Application Priority Data
Jun. 24, 2004 (JP) 2004-186960

(51) Int. Cl. G06F 15/16

(52) U.S. Cl. 709/230

(57) ABSTRACT

An information display apparatus for displaying the status of a system when data is transferred between a data supply source device and a data transfer destination device is provided. The information display apparatus includes a first display section displaying information about transfer data in the data supply source device, and a second display section displaying information about a storage area for transfer data in the data transfer destination device.

### CROSS REFERENCES TO RELATED APPLICATIONS

The present invention contains subject matter related to Japanese Patent Application JP 2004-186960 filed in the Japanese Patent Office on Jun. 24, 2004, the entire contents of which are incorporated herein by reference.

### BACKGROUND OF THE INVENTION

1. Field of the Invention

The present invention relates to an information display apparatus for displaying the status of information processing to a user, an information display method for use therewith, and a computer program for use therewith, and in particular relates to an information display apparatus for displaying the status of a system when information is transferred between devices, an information display method for use therewith, and a computer program for use therewith.

More particularly, the present invention relates to an information display apparatus for displaying, to a user, the status of a data supply source device and the status in a data providing destination when data transfer is performed between devices, an information display method for use therewith, and a computer program for use therewith, and in particular relates to an information display apparatus for displaying the amount of data to be transferred in a data supply source device and information about a vacant area in a data transfer destination device, an information display method for use therewith, and a computer program for use therewith.

2. Description of the Related Art

In association with recent technological advances, various kinds of desktop and notebook personal computers (PCs) have been developed and put in the market. These types of devices usually include an interface for connection with peripheral devices, are equipped with various peripheral devices, such as a keyboard, a mouse, a printer, and a modem, so that the operation environment is organized and hardware resources can be secured.

As an interface for personal computers, formerly, a serial port and a parallel port have been known. In recent years, USB (Universal Serial Bus) has become rapidly popular. There are abundant types of USB devices, for example, a keyboard, a mouse, a printer, a scanner, a modem, a hard disk drive, a CD-RW drive, and a DVD drive. USB is a serial bus, so it has features that cables are comparatively thin, peripheral devices can be tree-connected using a hub, various transfer modes are supported, etc., and it is widely recognized as a general-purpose interface.

Some of peripheral devices have a self-running function in addition to those that are connected to a personal computer and that operate as peripheral devices. An example thereof is a battery-driven portable media player.

This type of electronic device operates as an externally provided hard disk device while it is connected to a personal computer via an interface such as a USB cable, and can normally store a computer file and can download video and audio content. On the other hand, when the electronic device is released from the connection with a personal computer (of course, OK even if it is being kept connected to the USB cable), it operates as a media player in a stand-alone state and can play back video and music content downloaded into the hard disk within the associated device.

For example, a portable electronic device that is connected to another device, such as a cellular phone or a personal computer, to enable coordinated operation has been proposed (for example, refer to Japanese Unexamined Patent Application Publication No. 2002-300238). According to this type of portable electronic device, not only can an independent operation be performed, but also cooperative coordinated operation is possible as a result of being connected and coordinated to another device, such as a cellular phone and a personal computer. As a result, systematized operation that expands and advances user interface through connection and coordination with other devices are possible, such as a function for mutually exchanging music data with other devices in order to output sound and audio, a function for performing a telephone conversation via a cellular phone serving as another device, and a function for remotely controlling other devices.

### SUMMARY OF THE INVENTION

It is common practice that, when a computer performs data processing, such as data transmission, data download, or data manipulation, the processing progress status and the system status are shown to a user so as to improve convenience.

For example, when a file is copied (transferred) between two devices, when a printout is performed in a locally connected printer, or when a program is installed into a system, it is common practice that the degree of the progress is displayed in percent, or the processing status is displayed in percent in a bar by using a GUI (Graphical User Interface) function.

During data transfer, not only the time that is necessary for the transfer process, but also whether or not there is a sufficient vacant area in the transfer destination is very important information.

For example, when data stored in a computer is copied (transferred) to another device such as an externally provided hard disk, an error, such as the capacity of the copying destination being insufficient, is displayed after data to be copied is selected and copying is started.

When a large volume file is to be copied, after some time after an instruction is issued to the system and processing is started, the fact that copying cannot be completed because the capacity is insufficient is reported, causing the user to feel annoyed.

When a file stored in a computer is transferred to an externally connected hard disk, the status of the file to be transferred in the computer serving as a data supply source and the status of the vacant area in the hard disk serving as a data transfer destination are necessary information for the user to smoothly perform a copying operation.

For example, the user may want to know files to be transferred to the computer serving as the data supply source and the total size thereof. How many of these files to be transferred should be actually transferred depends on how much vacant area is available in the hard disk serving as the data transfer destination. The vacant area in the hard disk can be increased by deleting files that are already stored in the hard disk.

In the computer system, a technique for displaying in numerical values the size of the unused area of a disk and the sizes of individual stored files is widely adopted. However, a technique for displaying, to a user, the status in the data supply source device and the status in the data providing destination when data transfer is performed between devices is not adopted.

The present invention has been made in view of the above-described technological problems. It is desirable to provide a superior information display apparatus capable of displaying, to a user, the status of information processing, a superior information display method for use therewith, and a superior computer program for use therewith.

It is desirable to provide a superior information display apparatus capable of displaying, in a manner for a user to easily understand, the status of a system when information is to be transferred between devices, a superior information display method for use therewith, and a superior computer program for use therewith.

It is desirable to provide a superior information display apparatus capable of displaying, in a manner for a user to easily understand, the status in a data supply source device and the status in a data providing destination when data transfer is performed between devices, a superior information display method for use therewith, and a superior computer program for use therewith.

It is desirable to provide a superior information display apparatus capable of displaying the status of two devices so that transfer data can be selected in a data supply source device while confirming the amount of data to be transferred in the data supply source device and the status of the a area in a data transfer destination device, a superior information display method for use therewith, and a superior computer program for use therewith.

According to an embodiment of the present invention, there is provided an information display apparatus for displaying the status of a system when data is transferred between a data supply source device and a data transfer destination device, the information display apparatus including: a first display section displaying information about transfer data in the data supply source device; and a second display section displaying information about a storage area for transfer data in the data transfer destination device.

Here, the first display section may display information about the size of transfer data stored in the data supply source device. More specifically, the total size of all the data to be transferred, which is stored in the data supply source device, and the total size of the transfer data selected so as to be actually transferred are displayed.

On the other hand, the second display section may display information about a vacant area in the storage area of the data transfer destination device. More specifically, the total size, the used size, and the unused size of the storage area of the storage device possessed by the data transfer destination device are displayed.

Then, the first display section and the second display section may simultaneously display the total size of the transfer data in the data supply source device and the unused size of the storage area in the data transfer destination device, so that whether or not transfer is possible can be visually determined.

In the data transfer destination device, when data that is already stored in the storage area can be specified so as to be deleted, the second display section may jointly display the total size of the data that is specified so as to be deleted within the used size. In this case, even when the size of the unused area in the data transfer destination device is less than the total size of the transfer data, it becomes possible to easily determine whether or not transfer is possible by deleting the data that is specified so as to be deleted.

The first display section and the second display section may display, for example, each piece of information in a bar graph form. The user can select as desired data that is actually started to be transferred from within the data registered in a transfer source list and can transfer only the selected data. Then, according to the embodiment of the present invention, by simultaneously displaying the total size of the data registered in the transfer source list and the total size of the data selected for transfer in the graph in which capacities are displayed, it is possible to visually determine whether or not a transfer is possible. For example, the two graphs are formed from bar graphs, the first display section fills the total size of transfer data from the lower end of the bar graph, and the second display section fills the size of the used area of a transfer destination from the upper end of the bar graph. Thus, it is directly possible to compare the total size of the transfer data with the vacant capacity.

Here, the first display section may align the height of the bar graph to the height of the total size of the storage area or the size of the unused area in the data transfer destination device. As a result of the above processing, it becomes easier to visually understand the relationship between the total size of the transfer data in the data supply source device and the size of the unused area in the data transfer destination device.

The first display section and the second display section may set a mark on a point of particular interest in each graph, making easier the comparison. For example, in each graph, a mark is set at a point of particular interest, making the comparison easier. For example, in the bar graph, a mark is set in each of the total size of the transfer data on the data supply source device side and the unused capacity in the data transfer destination device. When the mark positions in both graphs coincide or are oppositely positioned, it is possible to allow the user to pay attention by changing colors or by displaying a message to the user.

When data is transferred, there are cases in which the data format is converted, such as re-encoding. For example, it is common practice that video data stored in an MPEG2 format in a personal computer is converted into an MPEG4 format having a lower bit rate when the video data is transferred to a portable device. In such a case, the data size changes after undergoing the data transfer. Therefore, the first display section may display the total size of the transfer data after the format conversion by computing or predicting the total size.

When the total size of the transfer data that is selected so as to be transferred from the data supply source device exceeds the vacant size of the storage area in the data transfer destination device, the first display section or the second display section may report an insufficient vacant capacity. For example, it is possible to notify the user of the fact that the remaining capacity of the transfer destination is insufficient by changing colors or by displaying an error message.

In a system for performing data transfer between devices, for example, a user interface including a transfer source list display area for list-displaying a transfer source list in which all files to be transferred in the data supply source device are registered, and a transfer source list display area for list-displaying a transfer destination list in which all the files that have already been transferred to the data transfer destination device are registered.

The user can specify a transfer file in the transfer source list display area. The first display section may compute and display the total size of the transfer files specified in the transfer source list display area.

The second display section may determine and display the used size and the unused size on the basis of the total size of the files registered in the transfer destination list. When files can be specified so as to be deleted in the transfer destination list display area, the second display section may determine the total size of the files specified so as to be deleted and may display the total size in such a manner as to be distinguished from the used size and the unused size.

According to another embodiment of the present invention, there is provided a computer program written in a computer-readable format, the computer program enabling a computer to perform processing for displaying the status of a system when data is transferred between a data supply source device and a data transfer destination device, the computer program including the steps of: displaying information about transfer data in the data supply source device; and displaying information about a storage area for transfer data in the data transfer destination device.

The computer program according to the embodiment of the present invention is such that a computer program written in a computer-readable format is defined so as to implement predetermined processing in a computer system. In other words, by installing the computer program according to the embodiment of the present invention into a computer system, coordinated operation is exhibited in the computer system, and operational effect identical to that of the information display apparatus according to the embodiment of the present invention can be obtained.

According to the embodiments of the present invention, it is possible to provide a superior information display apparatus capable of displaying, in a manner for a user to easily understand, the status of a system when information is to be transferred between devices, a superior information display method for use therewith, and a superior computer program for use therewith.

According to the embodiments of the present invention, it is possible to provide a superior information display apparatus capable of displaying, in a manner for a user to easily understand, the status in a data supply source device and the status in a data providing destination when data transfer is performed between devices, a superior information display method for use therewith, and a superior computer program for use therewith.

According to the embodiments of the present invention, it is possible to provide a superior information display apparatus capable of displaying the status of two devices so that transfer data can be selected in a data supply source device while confirming the amount of data to be transferred in the data supply source device and the status of the a area in a data transfer destination device, a superior information display method for use therewith, and a superior computer program for use therewith.

According to the embodiments of the present invention, when data in a particular device is to be transferred to another device, the total capacity, the used capacity, and the remaining capacity of the transfer destination device are displayed, and also, the total size of the data to be transferred from now can be displayed simultaneously. For example, by displaying, in a graph, etc., the remaining capacity of the transfer destination and the total size of the data to be transferred from now side by side, it becomes easily possible for a user to visually determine whether or not a transfer is possible.

According to the embodiments of the present invention, the user can select as desired data that is actually started to be transferred from within the data that is registered in a transfer source list and can transfer only the selected data. For example, as a result of simultaneously displaying, in a graph in which capacities are displayed, the total size of the data that is registered in the transfer source list and the total size of the data selected for transfer, it is possible for the user to visually determine whether or not the data can be actually transferred.

According to the embodiments of the present invention, the total size of files that are selected for deletion, but are not yet deleted in the transfer destination list can be displayed in the graph in which capacities are displayed. In this case, in the transfer destination, it becomes possible to visually determine whether or not a sufficient vacant capacity can be ensured by deleting these files.

According to the embodiments of the present invention, the device that performs data transfer may have a function for converting the data format during data transfer. In this case, by displaying the size after conversion or the predicted size after conversion with respect to the total size of the transfer source data, it is possible to more accurately display as to whether or not a transfer is possible.

According to the embodiments of the present invention, a graph of the transfer source list and a graph of the transfer destination list are provided individually and can be arranged so that the total size of all the data registered in the transfer source list or the data selected for transfer can be directly compared with the remaining capacity or the capacity such that the capacity that is to be deleted is added to the remaining capacity. For example, by forming the two graphs by bar graphs and by filling the graph of the transfer source list from the lower end thereof and filling the size of the used area of the transfer destination from the upper end thereof, the total size of the transfer data can be directly compared visually with the vacant capacity.

According to the embodiments of the present invention, even when the total of the data selected for transfer exceeds the remaining capacity of the transfer destination, it is possible to notify the user of the fact that the remaining capacity of the transfer destination is insufficient by changing colors or by displaying an error message.

According to the embodiments of the present invention, in each graph, a mark is set at a point of particular interest, making the comparison easier. For example, when the mark positions in both graphs coincide or are oppositely positioned, it is possible to allow the user to pay attention by changing colors or by displaying a message to the user.

### BRIEF DESCRIPTION OF THE DRAWINGS

FIG. 1 is a schematic view showing the hardware configuration of a personal computer;

FIG. 2 is a schematic view showing the hardware configuration of a USB device according to an embodiment of the present invention;

FIG. 3 shows an example of the structure of a GUI screen of an application program for transferring a file from a computer to a USB hard disk;

FIGS. 4A and 4B show examples of the structure of a transfer source capacity bar and a transfer destination capacity bar;

FIGS. 5A and 5B show examples of displays of a capacity bar when the total size of data selected for transfer exceeds the remaining capacity of a transfer destination;

FIGS. 6A and 6B show states in which markers are set at positions of sizes of interest in each graph of the capacity bar;

FIGS. 7A and 7B show examples of displays in which all elements of a transfer source capacity bar and a capacity bar during transfer are packed in one graph;

FIG. 8 is a flowchart showing a processing procedure for displaying the transfer source capacity bar; and

FIG. 9 is a flowchart showing a processing procedure for displaying the transfer destination capacity bar.

### DESCRIPTION OF THE PREFERRED EMBODIMENTS

Embodiments of the present invention will now be described below with reference to the drawings.

A. Apparatus Configuration

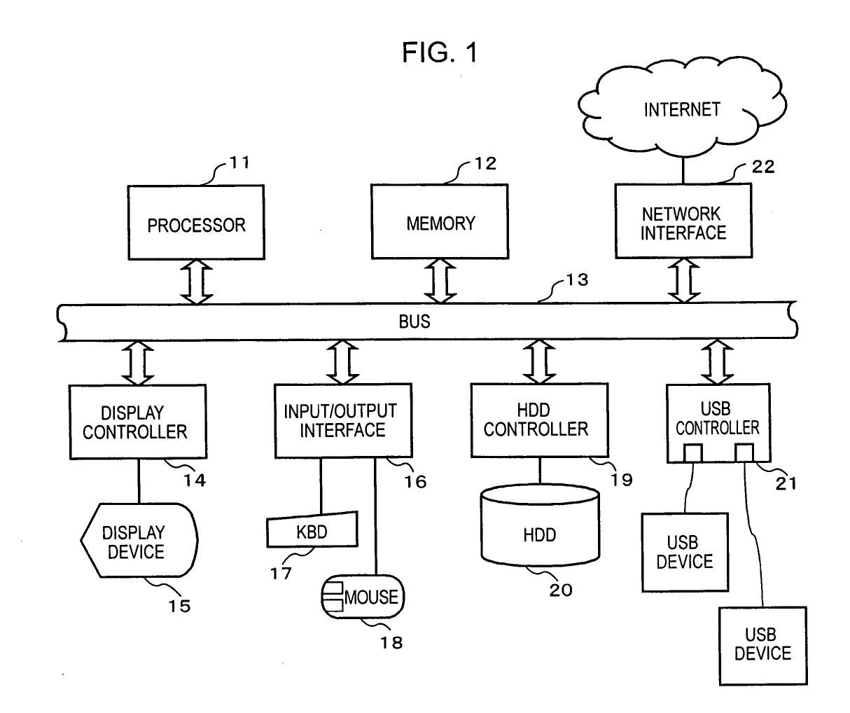

FIG. 1 is a schematic view showing the hardware configuration of a personal computer.

This system is mainly formed by a processor 11. In the program execution environment provided by the operating system (OS), the processor 11 performs various kinds of processing in accordance with a program stored in a memory 12. Also, the processor 11 controls various kinds of peripheral devices connected thereto via a bus 13. The peripheral devices connected to the bus 13 are as follows.

The memory 12 is formed of a semiconductor memory, such as a DRAM (Dynamic RAM), and is used to load program code to be executed in the processor 11 and to temporarily store work data for an execution program. The memory 12 constitutes the memory space of the processor 11.

A display controller 14 generates a display image in accordance with a drawing command sent from the processor 11 and sends the display image to a display device 15. The display device 15 is connected to the display controller 14, and displays and outputs, on its screen, the image in accordance with the display image information sent from the display controller 14.

In this embodiment, the display controller 14 supports a bit-map display format, and the operating system provides a GUI (Graphical User Interface) operation environment on the screen of the display device 15. Therefore, on the desktop, a plurality of icons representing application programs, other programs, and hardware resources such as a printer, are displayed. As a result of a user applying a direct operation on an icon, desired processing is started up. In this embodiment, when data transfer is performed between the operating system and peripheral devices, the status in a data supply source device and the status in a data providing destination device can be displayed in a manner for a user to easily understand. The details thereof will be described later.

A keyboard 17 and a mouse 18 are connected to an input/output interface 16, and the input/output interface 16 transfers a signal input from the keyboard 17 and the mouse 18 to the processor 11.

A network interface 22 is connected to an external network, such as a LAN and the Internet, and controls data communication via the Internet. That is, data sent from the processor 11 is transferred to another device in the Internet, and data sent via the Internet is received and passed to the processor 11. For example, programs, data, etc., can be externally received via a network.

A hard disk drive (HDD) controller 19, to which is connected a large-capacity external storage device 20, controls input and output of data to and from the HDD 20. In the HDD 20, the program of the operating system (OS) that should be performed by the processor, application programs, driver programs, and furthermore, data, content, etc., which is referred to or played back by the program, are stored.

A USB controller 21 has one or more USB ports and realizes an interface protocol between the USB controller 21 and a USB device that is connected via a USB cable. USB is a serial bus, so it has features that cables are comparatively thin, peripheral devices can be tree-connected using a hub, various transfer modes are supported, etc., and it is widely recognized as a general-purpose interface.

Examples of USB devices include a keyboard, a mouse, a printer, a scanner, a modem, a hard disk drive, a CD-RW drive, and a DVD drive. Some of USB devices have a self-running function in addition to those operating as a peripheral device connected by a USB cable. An example thereof is a USB hard disk that also operates as a portable media player.

An authorized USB device is recognized by a personal computer serving as a USB host by undergoing an initialization process called “configuration”. For example, after the USB hard disk is recognized by the configuration procedure, it is placed under the management of the file system, and normal file access becomes possible.

In this embodiment, when a file is transferred from a personal computer to a USB hard disk that is USB connected, the total size of files to be transferred, which are stored in a local disk 20, and information about the vacant area in the USB hard disk are simultaneously displayed, so that the user can easily perform a file transfer operation in a manner for the user to easily understand. The details thereof will be described later.

When data content, such as video and music, is transferred from a personal computer to a USB hard disk that is USB connected, it is preferable that a scramble process be performed from the viewpoint of content protection. As a result of performing a scramble process on the content, when the USB hard disk is connected to another computer, even if content is extracted from a portable electronic device by a file operation that is standard for the operating system without using a special software tool, it is difficult to create a file in a format that can be played back using a general-purpose application program. Therefore, it is possible to protect content from unauthorized usage (for example, refer to Japanese Patent Application No. 2004-170508 that has already been assigned to the applicant of the present invention).

In order to construct an information processing apparatus, such as a personal computer, in addition to those shown in FIG. 1, many electrical circuits are necessary. However, these are well known to a person skilled in the art and do not constitute the gist of the present invention. Thus, they are omitted in this specification. Furthermore, in order to avoid complexity of the drawings, it should be noted that only some of the connection between hardware blocks in FIG. 1 are shown.

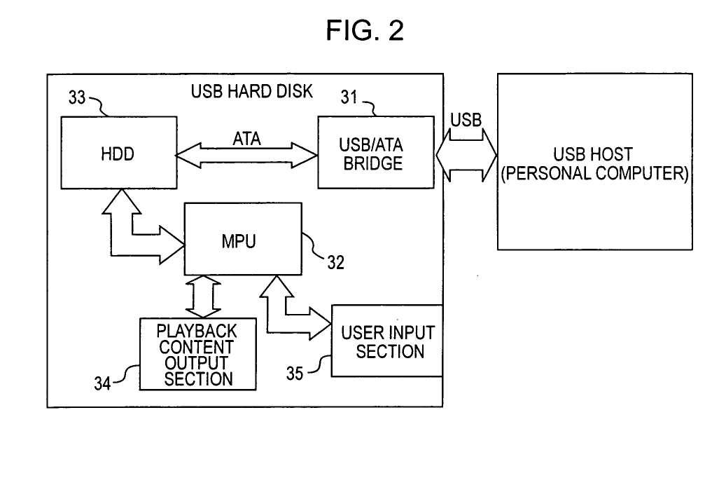

FIG. 2 is a schematic view showing the hardware configuration of a USB device according to an embodiment of the present invention.

The USB hard disk according to this embodiment is a hard disk device that incorporates a hard disk and that includes a USB interface. When the USB hard disk is connected to a USB cable, by assuming that it is an authorized USB device, the configuration procedure is performed, the USB hard disk is recognized from the personal computer, and it can operate as a large-capacity storage device.

Furthermore, the USB hard disk has a self-running function, operates as a battery (not shown)-driven portable media player incorporating a hard disk, and can play back video and music content within the hard disk inside the associated device. By considering that the USB hard disk operates as a portable device, when data is transferred from the personal computer to the USB hard disk, format conversion such as re-encoding may be performed. For example, video data stored in an MPEG2 format in the personal computer is converted into an MPEG4 format having a lower bit rate.

The USB hard disk shown in FIG. 2 includes a USB/ATA bridge 3 1, an MPU 32, a hard disk drive (HDD) 33, a playback content output section 34, and a user input section 35.

The USB/ATA bridge 31 is a protocol conversion IC through which the HDD 33 of an ATA interface is connected to the USB interface and is used. The USB/ATA bridge 3 1, which is implemented using, for example, a USB controller IC and a general-purpose one-chip microcomputer, develops firmware stored in a built-in ROM or an externally provided ROM onto a built-in RAM, and can perform predetermined processing. For example, the USB/ATA bridge 31 has in advance, as firmware stored in the built-in ROM, functions necessary for enabling a storage device such as an HDD to operate as a device of the USB mass storage class standard. Furthermore, a rewritable ROM that is externally provided enables a program for USB devices, such as firmware during charging mode, to be comparatively easily and inexpensively changed.

An MPU (Micro Processing Unit) 32 is a main controller for centrally controlling the overall operation of this apparatus, and mainly performs initialization and self-diagnostic processes when the power supply is switched on, management of an operation mode in response to the connection or non-connection of a USB cable (USB host) to the USB/ATA bridge 31, operation control during self-running of playback of video and music content stored in the HDD 33, etc.

When the USB hard disk is connected to the personal computer via the USB cable, it operates as an external storage device of the personal computer, and can normally store a computer file and can download video and audio content. When the USB cable is removed, the USB hard disk can operate as a portable media player on the basis of the self-running function and can play back and output content stored in the HDD 33. The operation mode as a USB hard disk is not limited to such a definition, and the USB hard disk may operate in a self-running manner, for example, even if it is being kept in a USB-connected state.

When content is downloaded from the personal computer to the HDD 33, a scramble process is performed for the purpose of content protection (as stated above). When content is played back, the MPU 32 descrambles the content output from the HDD 33 and performs in real time a process for decoding content that is coded in a WAV or MP3 format.

The HDD 33 functions as an external storage device for the personal computer that is USB-connected, and also functions as a media recording device when the USB hard disk operates as a portable media player on the basis of the self-running function.

The HDD 33 according to this embodiment is an HDD compliant with the ATA (AT Attachment) specification, and has self-monitoring and failure prediction functions of SMART (Self-Monitoring, Analysis and Reporting Technology) in order to prevent a failure from occurring in the HDD and from valuable stored data being lost. Then, a SMART log area for recording log data of attribute values by the SMART function is provided in a predetermined area on the hard disk. It is not possible to access this SMART log area by the command of the USB mass system storage class (that is, from a computer via the USB interface as in the past).

ATA (AT Attachment) is a standard in which IDE (Integrated Device Electronics), which is a de facto standard, for connecting a hard disk to the bus inside a personal computer is standardized.

The playback content output section 34 is formed of a display, a speaker, etc., for outputting video images and sound, correspondingly, when content is played back on the basis of the self-running function. The user input section 35 is a user interface for performing a key operation during playback, such as playback, stoppage, fast forwarding, rewinding.

B. Information Display During Data Transfer

It is common practice that, when a computer performs data processing, such as data transmission, data download, or data manipulation, the processing progress status and the system status are displayed to a user so as to improve convenience.

For example, during data transfer, not only the time that is necessary for the transfer process, but also whether or not there is a sufficient vacant area in the transfer destination is very importance information. More specifically, the status of the file to be transferred in the computer serving as a data supply source and the status of the vacant area in the hard disk serving as a data transfer destination are necessary information for the user to smoothly perform a copying operation.

First, the user wants to know files to be transferred to the computer serving as the data supply source and the total size thereof. How many of these files to be transferred should be actually transferred (that is, transferable files) depends on how much a vacant area is available in the hard disk serving as the data transfer destination. The vacant area in the hard disk can be increased by deleting files that are already stored in the hard disk.

Therefore, in this embodiment, an interface for simultaneously displaying the status of disks of the two devices is provided so that transfer data can be selected in the data supply source device while confirming the amount of data to be transferred in the computer and the status of the vacant area in the USB hard disk. When a plurality of files are selected and transferred to another device, as a result of visually displaying the remaining capacity of the transfer destination and the total size of the files to be transferred so as to make easier the comparison with the remaining capacity, it becomes possible for the user to easily understand the sufficient or insufficient capacity.

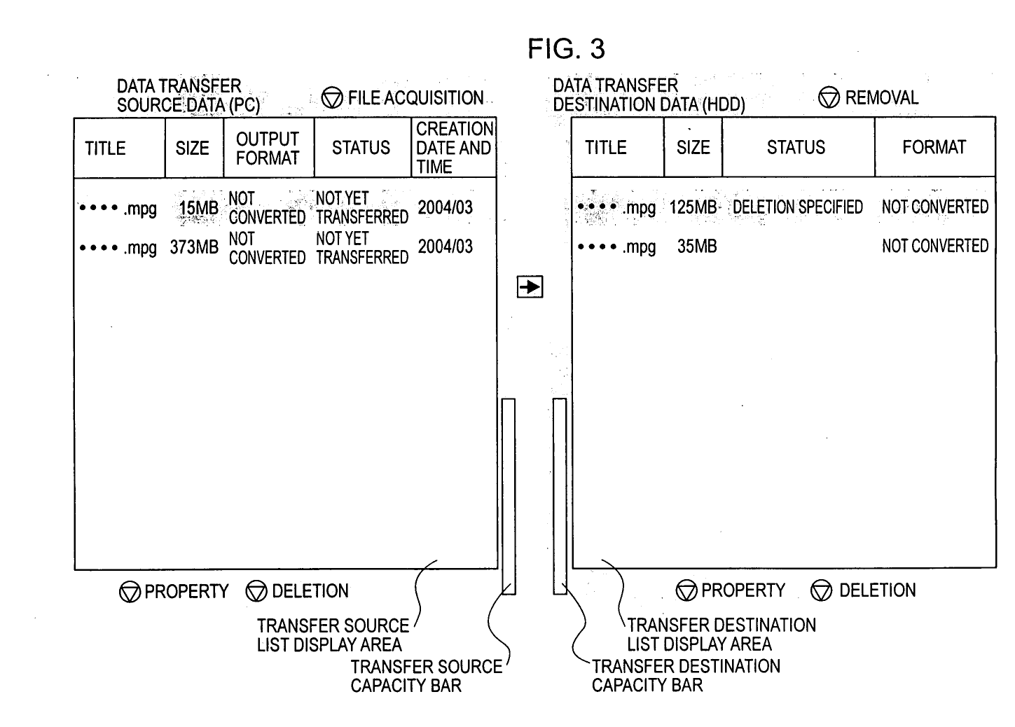

FIG. 3 shows an example of the structure of a GUI screen of an application program for transferring a file from a computer to a USB hard disk.

The screen shown in FIG. 3 has lists provided on the right and left. In the list on the left side, a list of data to be transferred (transfer source list), which is stored in a local disk on the computer side, is displayed. In the list on the right side (transfer destination list), a list of data that is already stored in the USB hard disk, which is a transfer destination, is displayed. When the data is not yet transferred, the transfer destination list on the right side becomes blank.

The user specifies transfer data from within the transfer source list by performing a selection operation, such as clicking a desired entry displayed in the transfer source list. When a transfer is performed, all the data in the transfer source list on the left side can be sent in one operation. Alternatively, the data can also be sent in such a way that files are specified one by one from within that list and are sent sequentially and that a plurality of pieces of data are selected as desired from within the transfer source list and are sent.

When a transfer is performed, the conversion of file format can also be performed. For example, an image file in an in an MPEG2 format can be re-encoded into an MPEG4 format having a lower bit rate and can be transferred. In this case, in which the size of the file before transfer (that is, present in the local disk of the computer) possibly differs from the size of the file of the transfer destination, that is, after copying.

Files can be specified so as to be deleted by performing a selection operation, such as clicking a desired entry displayed in the transfer destination list. Files that are specified so as to be deleted are only placed in a deletion-specified state and are not yet deleted, and is not added to the unused size. Files that are specified so as to be deleted can be used (played back) as usual (or the deletion specification is released so as to restore the files to their original state so as to be usable). As a result of performing a deletion by, for example, pressing the deletion button, the files that are specified so as to be deleted are completely deleted.

On the file transfer operation screen according to this embodiment, a “transfer source capacity bar” for displaying size information about files to be transferred in the local disk, which is a transfer source, and size information about files that are actually transferred, and a “transfer destination capacity bar” for displaying the size information of the vacant area in the transfer destination are displayed simultaneously. The transfer destination capacity bar displays not only the size of the actual vacant area, but also the size of the vacant area, which is obtained by actually deleting the files that are already specified so as to be deleted. These two capacity bars visually display the remaining capacity in the transfer destination and the total size of the files to be transferred. Thus, the comparison with the remaining capacity becomes easier, and it becomes easier for the user to understand the sufficient or insufficient capacity during file transfer.

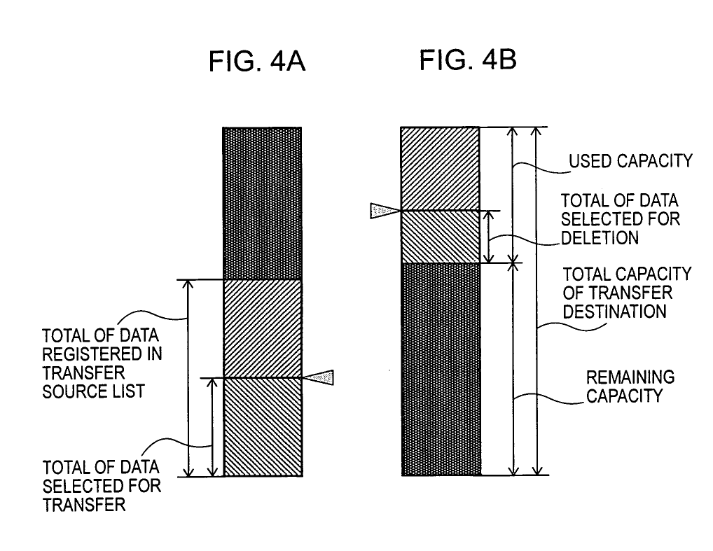

FIGS. 4A and 4B show examples of the structure of a transfer source capacity bar and a transfer destination capacity bar. In the examples shown in FIGS. 4A and 4B, the capacity bar is formed by using a bar graph form. The gist of the present invention is not limited to this example.

The graph of the transfer source capacity bar shown in FIG. 4A shows the data size of the transfer source list. In the example shown in FIG. 4A, the upper limit of the graph (the height of the bar graph) is set as the total capacity possessed by the USB hard disk serving as a data transfer destination device.

In FIG. 4A, the total size of the data present in the transfer source list is indicated by the left oblique line, and the total size of the data selected for transfer from within the above data is indicated by the right oblique line. This graph easily enables the user to visually recognize as to which degree of ratio these values become with respect to the total capacity of the transfer destination.

The left oblique line portion+the right oblique line portion=the total size of all the data registered in the transfer source list

The right oblique line portion=the total size of the data selected for transfer

The dot portion=the area where the blue portion is subtracted from the total capacity of the transfer destination

Both the selected transfer data indicated by the right oblique line, and the transfer source list indicated by the left oblique line are filled up from the lower end of the bar graph, and reach the height corresponding to their respective total sizes.

On the other hand, the graph shown in FIG. 4B shows the data size of the transfer destination list on the right side. Similarly to FIG. 4A, the upper end of the graph indicates the total capacity of the transfer destination, and the total size of the already existing files is indicated by the left oblique line. Furthermore, the total size of the data being selected (not yet deleted) so as to be deleted in this list is indicated by the dark right oblique line. Based on the above, the following can be seen.

The dot portion=the size of the unused area (the remaining capacity)

The left oblique line portion=the size of the unused area

The right oblique line portion=the size of the used area that is decreased when the currently selected file is deleted

In the graph shown in FIG. 4B, the unused area (the dot portion) is filled up from the lower end of the bar graph and reaches the height corresponding to that size. This is for making it easier to make a magnitude comparison with the total size of the transfer data indicated by the right oblique line portion or with the total size of the transfer source list indicated by the left oblique line portion of the graph shown in FIG. 4A.

It can be easily seen that, for example, if the height of the total size of the data selected for transfer, which is indicated by the right oblique line portion of FIG. 4A, is lower than the height of the unused area (the remaining capacity) indicated by the dot portion of FIG. 4B, all the currently selected transfer data can be transferred.

Conversely, it can be seen at a glance that, if the height of the total size of the data selected for transfer, which is indicated by the right oblique line portion of FIG. 4A, is higher than the height of the unused area (the remaining capacity) indicated by the dot portion of FIG. 4B, the capacity for transferring all the selected transfer data is insufficient in the transfer destination.

When the capacity is insufficient on the side of the USB hard disk serving as a data transfer destination device, a method for increasing the capacity by decreasing the number of files to be transferred from the PC serving as a data supply source device or by deleting unnecessary files in the transfer destination may be used.

In the transfer destination list in FIG. 3, the size of the data selected for deletion is indicated as in the right oblique line portion of FIG. 4B. The total size of this deletion-specified data is positioned between the unused area indicated by the dot portion and the used area indicated by the left oblique line. The portion where the unused area indicated by the dot portion and the deletion-specified data area indicated by the right oblique line are added together indicates the size of the unused area, which is obtained after the deletion-specified file is deleted. Then, if this total size is higher than the total size of the transfer data indicated by the right oblique line portion of FIG. 4A, it can be visually understood that a space necessary for transfer can be secured by deleting the files.

Furthermore, the height at which the right oblique line portion and the left oblique line portion of FIG. 4A are added together enables the size when all the data in the transfer source list is transferred to be compared with the size of the unused area indicated by the dot portion of FIG. 4B, or the sum of the unused area indicated by the dot portion of FIG. 4B and the total size of the deletion-specified data indicated by the right oblique line portion.

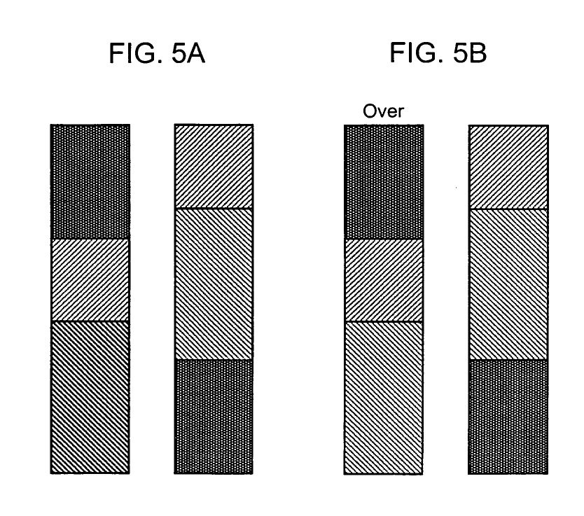

FIGS. 5A and 5B show examples of displays of a capacity bar when the total size of data selected for transfer exceeds the remaining capacity of a transfer destination. In the example of FIG. 5A, when the size of the selected data exceeds the remaining capacity, the display of the total size of the transfer data is changed from the right oblique line to the dark right oblique line. Instead of changing the display form of colors, patterns, etc., in the graph, as shown in FIG. 5B, a character by which an excess can be seen, such as “Over”, may be displayed at an appropriate position on the screen, or a mark, such as “!”, indicating that the size of the selected data exceeds the remaining capacity may be displayed at an appropriate position on the screen.

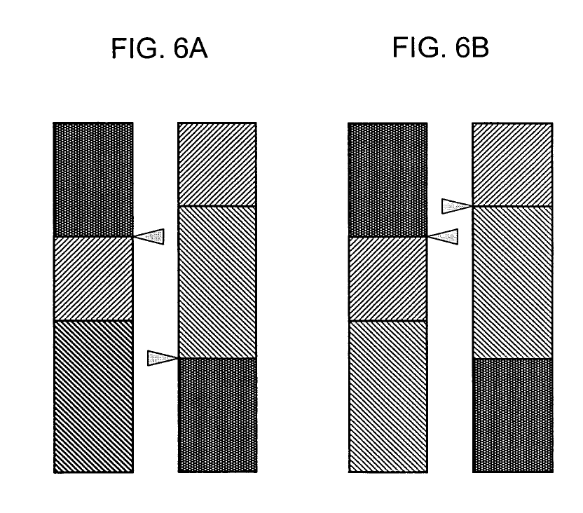

In the examples shown in FIGS. 6A and 6B, the total size (the right oblique line portion) of the transfer data selected in the transfer source is compared with the remaining capacity (the dot portion) in the transfer destination. Those values to be compared are the following.

[The Transfer Source List]

The right oblique line portion+the left oblique line portion=the total size of all the data in the transfer source list

The right oblique line portion=the total size of the selected transfer data

[The Transfer Destination List]

The dot portion=the size (the remaining capacity) of the unused area

The dot portion+the right oblique line portion=the size of the unused area after deletion is performed

Among the above values, which values should be compared in the transfer source list and the transfer destination list depends on the status. If these can be selected freely, convenience is improved. For example, as shown in FIGS. 6A and 6B, markers are made to be capable of being set at positions of sizes of interest in each graph of the capacity bar.

FIG. 6A shows a case in which the total size of the transfer source list indicated by the right oblique line and the left oblique line in the transfer source is compared with the size of the unused area indicated by the dot portion in the transfer destination. In this example, blue+light blue is over the remaining capacity.

FIG. 6B shows a case in which the marker in the transfer destination is set to a usable area by deleting the deletion-specified file indicated by the dot portion and the right oblique line portion in the transfer destination. As a result, if the deletion-specified file is deleted and the right oblique line portion is added, the fact can be seen at a glance that the size becomes a value greater than the size of the entire transfer source list indicated by the right oblique line portion and the left oblique line portion in the transfer source, that is, a sufficient vacant area capable of transferring the entire transfer source list can be secured.

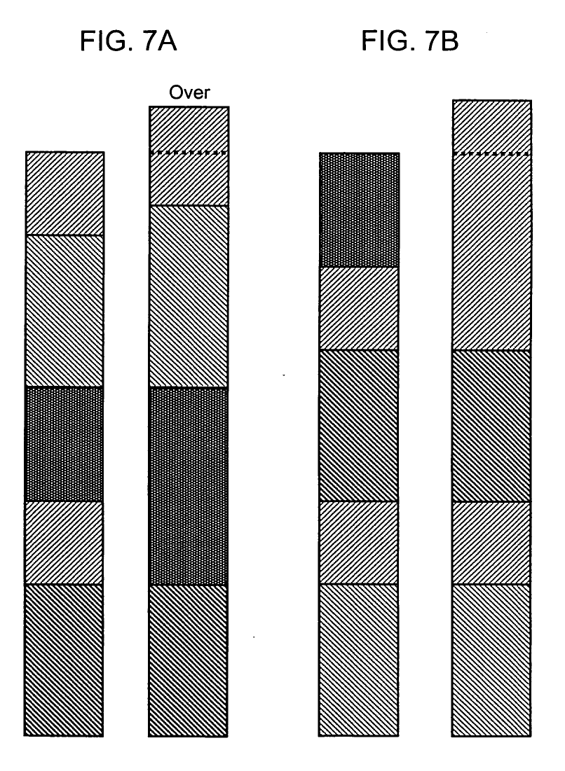

FIGS. 7A and 7B show examples of displays in which all elements of a transfer source capacity bar and a capacity bar during transfer are packed in one graph.

FIG. 7A differs from FIG. 7B in that only the sequence of arranging elements differs. When FIG. 7A is used as an example, in the graph on the left side, the dot portion is seen, and it can be seen that the remaining capacity is enough. On the other hand, in the graph on the right side, the total height exceeds the entire capacity, and if the dark gray portion is deleted, the total height falls within the capacity.

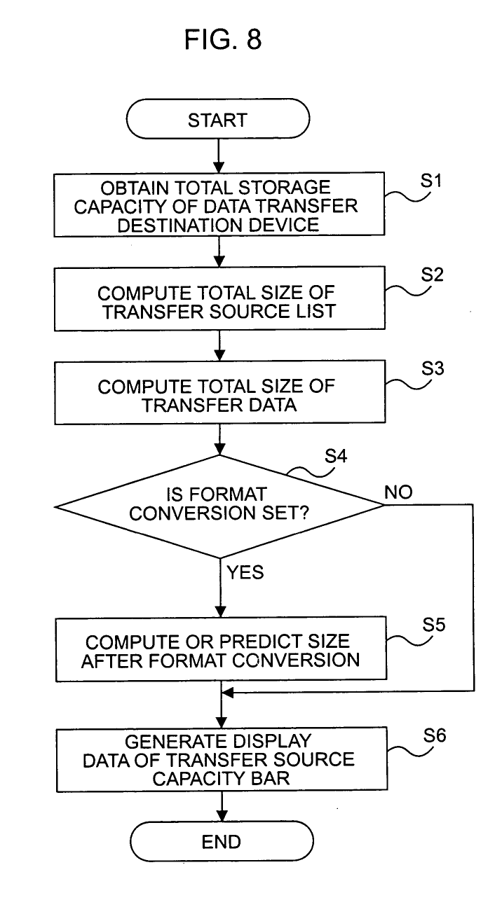

FIG. 8 is a flowchart showing a processing procedure for displaying a transfer source capacity bar.

Initially, the total storage capacity in the data transfer destination device is obtained (step S1).

Then, the total size of the entire transfer source list is computed (step S2). Next, the total size of the transfer data that is specified so as to be deleted in the transfer source list is computed (step S3).

Here, it is computed whether or not a data format conversion should be performed during data transfer (step S4). When the data format conversion is set, the size during the format conversion is computed or predicted on the basis of the total size of the transfer source list and the transfer data, which is computed in the above processing step (step S5).

The total size of the transfer source list and the total size of the transfer data, which are obtained in this manner, are mapped onto a bar graph having, as a height, the total storage capacity of the data transfer destination device, generating the display data of the transfer source capacity bar (step S6).

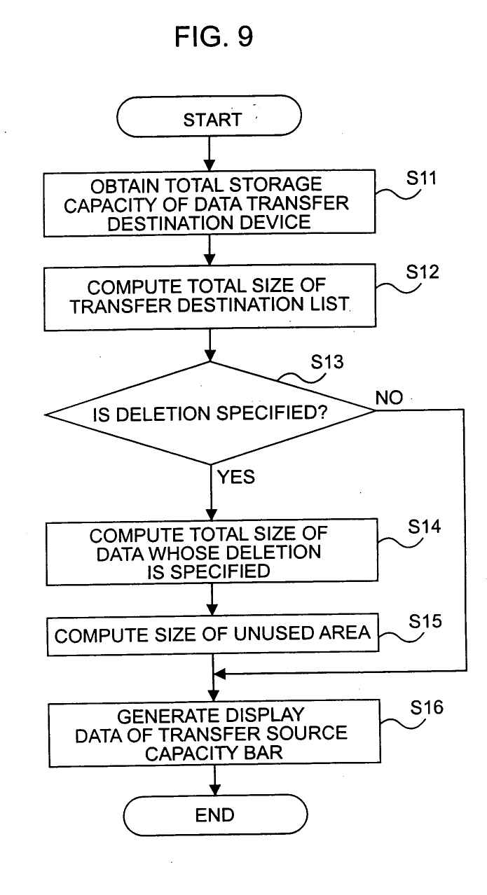

FIG. 9 is a flowchart showing a processing procedure for displaying a transfer destination capacity bar.

Initially, the total storage capacity in the data transfer destination device is obtained (step S11).

Next, the total size of the data that has already been transferred to the data transfer destination device, that is, the entire transfer destination list, is computed (step S12).

Next, a check is made to determine whether or not there is data that is specified so as to be deleted in the transfer destination list (step S13). Here, when there is data that is specified so as to be deleted, the total size thereof is computed (step S14).

Next, the total size of the transfer destination list is subtracted from the total storage capacity in order to compute the size of the unused area (step S15).

The total storage capacity of the data transfer destination device, the total size of the data that is specified so as to be deleted, and the size of the unused area, which are obtained in this manner, are mapped onto the bar graph in order to generate the display data of the transfer destination capacity bar (step S16).

In this specification, by using as an example a case in which a file is transferred from a computer to an externally provided USB hard disk, the embodiments of the present invention for displaying the status in the data supply source device and the status in the data providing destination to the user have been discussed above. However, the gist of the present invention is not limited to these embodiments. Even when data transfer is performed between devices in a combination other than the above, by applying the present invention, it becomes possible for the user to select transfer data in the data supply source device while confirming the amount of data to be transferred in the data supply source device and the status of the vacant area in the data transfer destination device.

In summary, the present invention has been disclosed in the form of examples, and the description content of this specification should not be construed as being limited. In order to determine the gist of the present invention, the claims should be taken into consideration.

It should be understood by those skilled in the art that various modifications, combinations, sub-combinations and alterations may occur depending on design requirements and other factors insofar as they are within the scope of the appended claims or the equivalents thereof.

1. An information display apparatus for displaying the status of a system when data is transferred between a data supply source device and a data transfer destination device, the information display apparatus comprising:
a first display section displaying information about transfer data in the data supply source device; and
a second display section displaying information about a storage area for transfer data in the data transfer destination device.

2. The information display apparatus according to claim 1, wherein the first display section displays information about the size of transfer data stored in the data supply source device, and
the second display section displays information about a vacant area in the storage area of the data transfer destination device.

3. The information display apparatus according to claim 1, wherein the first display section displays the total size of all the data to be transferred, the data being stored in the data supply source device, and the total size of the transfer data selected to be actually transferred from all the data.

4. The information display apparatus according to claim 1, wherein the second display section displays the total size, the used size, and the unused size of the storage area of a storage device possessed by the data transfer destination device.

5. The information display apparatus according to claim 4, wherein data that is already stored in the storage area of the data transfer destination device can be specified so as to be deleted, and
the second display section displays the total size of the data that is specified so as to be deleted within the used size.

6. The information display apparatus according to claim 1, wherein the first display section and the second display section simultaneously display the total size of the transfer data in the data supply source device and the unused size of the storage area in the data transfer destination device.

7. The information display apparatus according to claim 6, wherein the first display section and the second display section display each piece of information in a graph form.

8. The information display apparatus according to claim 7, wherein the first display section and the second display section display each piece of information in a bar graph form, the first display section fills the total size of transfer data from the lower end of the bar graph, and the second display section fills the size of the used area of the transfer destination from the upper end of the bar graph.

9. The information display apparatus according to claim 8, wherein the first display section aligns the height of the bar graph to the height of the total size of the storage area or the size of the unused area in the data transfer destination device.

10. The information display apparatus according to claim 7, wherein the first display section and the second display section set a mark on a point of particular interest in each graph.

11. The information display apparatus according to claim 1, wherein, when the format of transfer data is converted when data is transferred from the data supply source device to the data transfer destination device, the first display section displays the total size of the transfer data after the format conversion by computing or predicting the total size.

12. The information display apparatus according to claim 1, wherein, when the total size of the transfer data that is selected so as to be transferred from the data supply source device exceeds the vacant size of the storage area in the data transfer destination device, the first display section or the second display section reports an insufficient vacant capacity.

13. The information display apparatus according to claim 1, further comprising a transfer source list for registering all files to be transferred in the data supply source device, and a transfer source list display area for list-displaying all the files registered in the transfer source list, a transfer file being capable of being specified in the transfer source list display area,
wherein the first display section computes and displays the total size of the transfer file specified in the transfer source list display area.

14. The information display apparatus according to claim 1, further comprising a transfer source list for registering all files that are already transferred to the data transfer destination device, and a transfer destination list display area for list-displaying all the files registered in the transfer destination list,
wherein the second display section determines and displays the used size or the unused size on the basis of the total size of the files registered in the transfer destination list.

15. The information display apparatus according to claim 14, wherein a file can be specified so as to be deleted in the transfer destination list display area, and
the second display section determines and displays the total size of the files whose deletion is specified.

16. An information display method for displaying the status of a system when data is transferred between a data supply source device and a data transfer destination device, the information display method comprising the steps of:
firstly displaying information about transfer data in the data supply source device; and
secondly displaying information about a storage area of transfer data in the data transfer destination device.

17. The information display method according to claim 16, wherein the first display step and the second display step simultaneously display the total size of the transfer data in the data supply source device and the unused size of the storage area in the data transfer destination device.

18. The information display method according to claim 16, wherein the first display step and the second display step display each piece of information in a graph form.

19. The information display method according to claim 18, wherein the first display step fills the total size of the transfer data from the lower end of a bar graph, and the second display step fills the size of the used area of the transfer destination from the upper end of a bar graph.

20. The information display method according to claim 19, wherein the first display step aligns the height of the bar graph to the height of the total size of the storage area or the size of the unused area in the data transfer destination device.

21. The information display method according to claim 16, wherein, when the format of the transfer data is converted when data is transferred from the data supply source device to the data transfer destination device, the first display step displays the total size of the transfer data after the format conversion by computing or predicting the total size.

22. A computer program written in a computer-readable format, the computer program enabling a computer to perform processing for displaying the status of a system when data is transferred between a data supply source device and a data transfer destination device, the computer program comprising the steps of:
displaying information about transfer data in the data supply source device; and
displaying information about a storage area for transfer data in the data transfer destination device.
